(19) United States
(12) Patent Application Publication
(10) Pub. No.: US 2008/0295911 A1
(43) Pub. Date: Dec. 4, 2008

(54) Hose inflation adapter kit

(76) Inventor: Billy Joe Davis, Marysville, OH (US)

Correspondence Address: Billy Joe Davis, 17360 West Darby Road, Marysville, OH, 43040, US

(21) Appl. No.: 11/807,385

(22) Filed: May 29, 2007

(51) Int. Cl. F16L 55/115; F16L 55/11

(52) U.S. Cl. 138/91; 138/93

(57) ABSTRACT

The invention provides a unique, compact tool to be used in conjunction with preexisting hoses of any type, construction, size or style whatsoever and inflating said hose or hoses in a safe universal manor with universal gas delivery devices using an appropriate adaptive valve and a safety pressure relief mechanism that also serves as a method to deflate the said hose or hoses after the need for a flotation device is no longer present in any situation whatsoever and by any amateur or professional applicant or user who may or may not be of any occupation whatsoever.

U.S. Pat. No. 7,172,367 Inflatable Hose System Feb. 6, 2007
U.S. Pat. No. 6,729,798 Flow diverter system May 4, 2004
U.S. Pat. No. 5,957,174 Spill containment system Oct. 19, 1999
U.S. Pat. No. 5,968,814 Portable system and method for controlling . . . Oct. 19, 1999
U.S. Pat. No. 5,855,454 Water safety and survival system Jan. 5, 1999
U.S. Pat. No. 5,620,018 Emergency spill collector Apr. 15, 1997
U.S. Pat. No. 4,174,186 Floating-type anti-oil anti-impact anti-wave . . . Nov. 13, 1979
U.S. Pat. No. 3,221,884 Apparatus for removing a surface layer from a . . . December 1965

### 1. DESCRIPTION OF THE PRIOR ART

All prior art has no direct reference to my invention and there is no product available on the market that will provide the requirements listed below. Prior art uses entire assemblies as a unit to be inflated including the air chamber and fails to meet the following criteria:

a. Existing Air Chamber: Users of my invention will have on their truck, apparatus, boat, ship, trailer or any other mode of transport; Fire Hose, Mill

Hose, LDH, Lay Flat Hose or any other type, size, shape, length of hose with any style, size or length of couple whatsoever. No prior art can be used with, modified to adapt or attach to existing air chamber to save valuable space in the mode of transport.

b. Safety Air Pressure Relief System: No prior art provides a reliable pressure relief system to ensure maximum pressure of the air chamber is not exceeded to prevent explosion and potential personal injury of the users.

c. Simplicity of Design: No prior art exhibits a simple design that requires no learning curve to adapt and use preexisting hose as a flotation device. The importance of this cannot be over emphasized as potential uses of my invention could include a tactical life saving requirement wherein a learning curve longer than a moment could mean the difference between life and death.

d. Compact Size: All prior art requires a large amount of storage space on the mode of transport. My invention requires no more room than already exists for the various adaptors preexisting on these modes of transport.

e. Source of Inflation Gases: No prior art provides for the flexibility to inflate an air chamber from a preexisting source. My invention can effect the inflation from any source with the installation of any fill valve that matches the preexisting source of inflation gases. Such source of inflation gases can be, but not limited to, Self Contained Breathing Apparatuses (SCBA), Self Contained Underwater Breathing Apparatuses (SCUBA), portable compressed air tanks, portable air compressors or by any other means whatsoever.

### 2. BACKGROUND OF THE INVENTION

I identified the need for a device to be compact, stored easily and adaptable to numerous inflation options. The greatest need was a safe flotation aid that will let the user provide the vessel (air chamber) to be inflated that is already being in use; and not an added item to take up space in the mode of transport.

I also noticed a need for a device to be universal to inflation tools such as compressed air, bottled air, and high-pressure gas of any means that are available to the users' environment. Potential users range from law enforcement to construction, fire fighting and rescue personnel, but the potential of needs by amateur or professional users are virtually endless and there are potentially countless undiscovered uses for a Hose Inflation Adapter Kit that can convert any hose into a flotation device.

### 3. BRIEF SUMMARY OF THE INVENTION

My invention is a Hose Inflation Adapter Kit that is comprised of a mechanically fabricated or modified plug and cap of any material including all metals, a gas filling valve that is universally adaptable to be used with any method of inflation, a pressure relief safety valve, a deflation device and a method to affix a positioning lead such as rope, wire, cord, cable or any other means whatsoever.

### 4. BRIEF DESCRIPTION OF DRAWINGS

(Photo Image for “ornamental” illustration)

The present art illustrates a general visual display of basic assembly and subassembly parts that can vary in appearance dependent on application, size, style, type, shape, construction, method of attachment or any other mechanical means to fit any hose connector for any size, style or type of hose whatsoever.

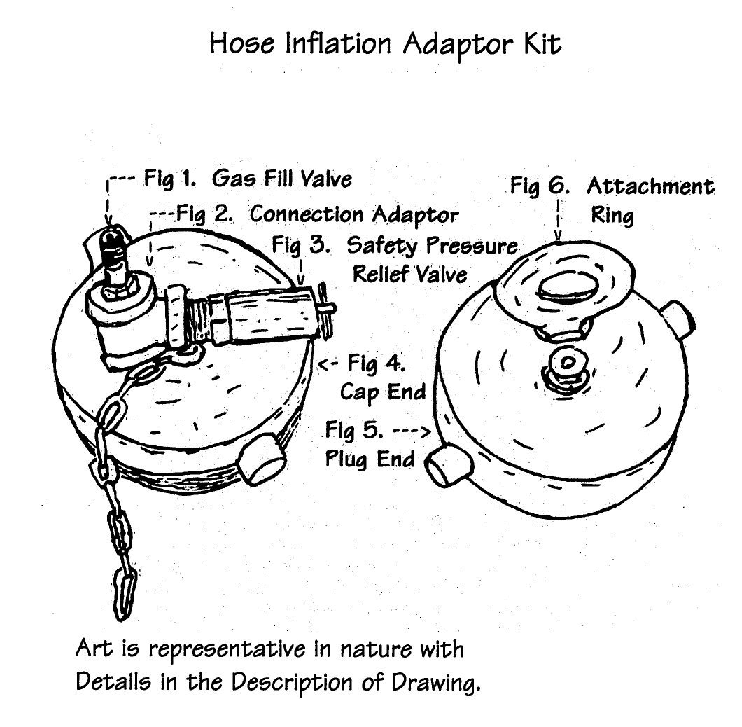

a. FIG. 1 is representative of the gas fill valve which can be modified, fabricated, custom machined, pre-manufactured or produced by any other method whatsoever to inject gases such as air into the air chamber such as a hose resulting from the retrofit of the adaptor kit to a preexisting hose as described in the Detailed Description of the Invention.

b. FIG. 2 is representative of a connection adaptor that my or may not be required in production to retrofit a plurality of other subassemblies to either the plug or cap end of the inventive intellectual property. These subassemblies can be but are not limited to those specified in FIGS. 1 and 3 of the present art. This can be modified, fabricated, custom machined, pre-manufactured or produced by any other method whatsoever and can be affixed or retrofit to either the plug or cap ends by casting, machining, drilling/threading/pressing or any other mechanical means whatsoever.

c. FIG. 3 is representative of a safety pressure relief valve, which can be modified, fabricated, custom machined, pre-manufactured or produced by any other method whatsoever to expel excess pressure when or if this pressure exceeds the threshold of what is required. This part also serves as a manual deflation valve present in all pressure relief valves and may be retrofit to either the plug or cap end adaptor.

d. FIG. 4 is representative of the cap end of the adaptor kit. This can be modified, fabricated, custom machined, pre-manufactured or produced by any other method whatsoever to fit onto or into the couple mechanism of a preexisting hose as described in the Detailed Description of the Invention.

e. FIG. 5 is representative of the plug end of the adaptor kit. This can be modified, fabricated, custom machined, pre-manufactured or produced by any other method whatsoever to fit onto or into the couple mechanism of a preexisting hose as described in the Detailed Description of the Invention.

f. FIG. 6 is representative of an attachment ring that could be required to attached an eyelet, loop, ring, snaple, or any other fitting to attach a rope, line, cord, wire, cable or any other method of towing, pulling or delivering the flotation device to the required aquatic location. This can be modified, fabricated, custom machined, pre-manufactured or produced by any other method whatsoever and can be affixed or retrofit to either the plug or cap ends by casting, machining, drilling/threading/pressing or any other mechanical means whatsoever.

### 5. DETAILED DESCRIPTION OF THE INVENTION

The current inventive adaptor fills the needs of end users in a way no other invention or marketed product can. There is no product available on the market that will provide the requirements and the end users who need this adaptor are using devices that unnecessarily include an air chamber that requires an extremely large storage compartment on the mode of transport. The modes of transport include but-are not limited to; Fire Trucks, trailers, apparatus, rescue vehicles, boats, ships, police cars or vans and other vehicles too numerous to list. The essential air chamber for a flotation device can be a preexisting hose that can be of any style or type. Such hoses include, but are not limited to Fire Hose, Mill Hose, LDH, Lay Flat Hose or any other suitable preexisting style or type of hose whatsoever. My invention consists of two main embodiments—a plug (female connector end) and a cap (male connector end). Either the cap or plug can be used for other retrofit parts, depending on application. The retrofit parts can include but are not limited to:

a. An air valve that can easily be exchanged for any type required to fit the output device for gases to fill the air chamber. These gas output devices can include but are not limited to Self Contained Breathing Apparatus (SCBA), Self Contained Underwater Breathing Apparatus (SCUBA), Fire Fighting and Rescue Breathing Apparatus (BA), portable compressed air tanks, portable air compressors or any other device whatsoever that can deliver gases under pressure.

b. A safety relief valve that can be, but is not limited to an existing device such as a pop off valve or any such device that is professionally manufactured and calibrated to relieve pressure when it approaches the maximum specification of the air chamber to which the device is attached or adapted to fit. This subassembly is also a manual pressure relief valve to safely deflate the flotation device.

c. A method of fitting the air input valve and safety relief valve to either the plug or cap adaptor. This can be, but is not limited to a connection fitting that is either part of or retrofit to either the plug or cap ends by such means as casting, machining, drilling/threading/pressing or any other mechanical means whatsoever.

d. An eyelet, loop, ring, snaple, or any other fitting to attach a rope, line, cord, wire, cable or any other method of towing, pulling or delivering the flotation device to the required aquatic location and can also be retrofit to either the plug or cap ends by casting, machining, drilling/threading/pressing or any other mechanical means whatsoever.

Unlike any existing device, the learning curve for use of my invention is so short it can only be measured as “a moment” and defined as obvious. The end users of my invention will simply connect the plug and cap ends to a preexisting hose that instantly creates an ensemble resulting in a flotation device for unlimited potential uses. Examples of uses include, but are not limited to:

a. First response amateur or professional life-saving personnel can use this kit in the event of an immanent drowning. This potential use could be as an on-site ensemble rescue device or any other need for a flotation device. 2. Boating safety equipment in the event of the need for a longer-reach flotation device. Unlike any existing device, the learning curve for use of my invention is so short it can only be defined as “in a moment.” A potential user in need of a flotation device for any reason can simply attach the plug and cap ends to a preexisting hose as described above and inflate the hose, safely creating an instant flotation device for a potentially unlimited number of uses.

b. Deflation of the flotation device is actuated with the manual feature of any pressure relief valve that may be retrofit to either the plug or cap end adaptor. At that time the Hose Inflation Kit Adaptors and the preexisting hose that was used, can be stowed back into the storage compartment from which they came.

1. I claim as my invention a unique, simplistic Hose Inflation Adapter Kit, that will convert various styles or types of lay flat hoses such as PVC, Fire or Mill hose to be inflated with any type of non explosive gas and used for the specific task of ice surface or water rescue with a plurality of advantages by attaching my adapter kit to existing hose which will save space, provide a rescue tool, allow existing hose to be multi-functional and also can be used for any other purpose that may require the safe inflation of said preexisting hose.
